(19) United States
(12) Patent Application Publication
(10) Pub. No.: US 2021/0206083 A1
(43) Pub. Date: Jul. 8, 2021

(54) BUILD MATERIAL PREPARATION IN ADDITIVE MANUFACTURING

(71) Applicant: HEWLETT-PACKARD DEVELOPMENT COMPANY, L.P., Houston, TX (US)

(72) Inventors: Haseeb YUSEF, Vancouver, WA (US); Fernando JUAN, Sant Cugat del Valles (ES); Corwin David WHITEFIELD, Vancouver, WA (US); Matt Gordon DRIGGERS, Vancouver, WA (US); Gerard MOSQUERA DONATE, Sant Cugat del Valles (ES)

(73) Assignee: HEWLETT-PACKARD DEVELOPMENT COMPANY, L.P., Houston, TX (US)

(21) Appl. No.: 16/074,808

(22) PCT Filed: Mar. 29, 2017
(86) PCT No.: PCT/US2017/024815

§ 371 Date: Aug. 2, 2018

(51) Int. Cl. B29C 64/314; B29C 64/329

(52) U.S. Cl. CPC B29C 64/314; B33Y 40/10; B29C 64/329

(57) ABSTRACT

In one example, a build material preparation subsystem. The subsystem includes a trough to house build material deliverable to a build bed and usable to form a layer of an object fabricated by additive manufacturing. An agitating tray is slidably disposed in the trough. A linear actuator is disposed adjacent an outside wall of the trough. A drive arm has a first end portion fixedly coupled to the agitating tray and a second end portion coupled to the linear actuator. The drive arm passes over a wall of the trough.

### BACKGROUND

Additive manufacturing systems, some of which may be referred to as 3D printers, are increasingly being used to fabricate three-dimensional physical objects for prototyping and/or production purposes. The physical object is constructed layer-by-layer through selective addition of a build material, rather than by traditional methods such as molding, or subtractive machining where material is removed by cutting or grinding.

### BRIEF DESCRIPTION OF THE DRAWINGS

FIG. 1 is a schematic representation of an additive manufacturing system in accordance with an example of the present disclosure.

FIG. 2 is a perspective view of a build material preparation subsystem usable with the additive manufacturing system of FIG. 1 in accordance with an example of the present disclosure.

FIG. 3A is a perspective view of another build material preparation subsystem usable with the additive manufacturing system of FIG. 1 in accordance with an example of the present disclosure.

FIG. 3B is a cross-sectional view of the build material preparation subsystem of FIG. 3A taken along the line 3B-3B, in accordance with an example of the present disclosure.

FIG. 4 is a perspective view of an agitating tray and a drive arm usable with the build material preparation subsystems of FIG. 2 and FIG. 3A, in accordance with an example of the present disclosure.

FIG. 5 is a schematic planar view of a drive arm usable with the build material preparation subsystems of FIG. 2 and FIG. 3A, in accordance with an example of the present disclosure.

FIG. 6 is an exploded perspective view of a linear actuator and drive arm usable with the build material preparation subsystems of FIG. 2 and FIG. 3A, in accordance with an example of the present disclosure.

FIG. 7 is a cross-sectional view of the drive arm and a cover of the linear actuator of FIG. 6 taken along the line 7-7, in accordance with an example of the present disclosure.

FIGS. 8A and 8B are cross-sectional views of the build material preparation subsystem of FIG. 2 taken along the line 8-8 at minimum and maximum stroke respectively, in accordance with an example of the present disclosure.

FIG. 9 is a flowchart of a method for preparing build material in an additive manufacturing system, in accordance with an example of the present disclosure.

FIG. 10 is a flowchart of another method for preparing build material in an additive manufacturing system, in accordance with an example of the present disclosure.

FIGS. 11A-11E are a sequence of schematic representations of the operation of a build material preparation subsystem, in accordance with an example of the present disclosure.

FIG. 12 is a schematic representation of a build material preparation subsystem having dual drive arms, in accordance with an example of the present disclosure.

### DETAILED DESCRIPTION

In additive manufacturing (AM) systems, a 3D digital representation or 3D model (i.e. the design) of the object to be fabricated may be divided (“sliced”) into a series of thin, adjacent parallel planar slices. The 3D object may then be fabricated layer-by-layer. Each slice of the representation generally corresponds to a layer of the physical object to be fabricated. During fabrication, the next layer is formed on top of the adjacent previous layer. In one example, each layer is about 0.1 millimeter in thickness. Such a fabrication process is one type of “additive manufacturing”:

Additive manufacturing systems fabricate a 3D object in a work area, also referred to as a build bed, and use a build material as the substance from which each layer of the 3D object is fabricated. In one example, the build material is a fine powder (particulate material), such as for example polyamide (nylon). Other build materials may be powders of a different material and/or having a different cohesive strength. In one example, the powder particles are in the range of 5 to 200 microns in size. In one example, the powder particles have an average size of 50 microns. During fabrication of each layer, the regions of the build material which correspond to the location of the object within the corresponding slice, are selectively fused together, while the other regions remain in unfused form. Once the object is completely fabricated, any unfused build material is removed, leaving behind the fabricated 3D object. In some examples, the unfused build material is removed within the additive manufacturing system, while in other examples the unfused build material is removed external to the additive manufacturing system.

A level-surface powder layer throughout the entire area of the build bed contributes to the fabrication of 3D parts having high quality—for example, smooth surfaces, no unintended voids, etc. Some additive manufacturing systems might vibrate the build bed after the powder layer has been added in order to self-level the powder layer in the build bed. However, vibrating the build bed can be undesirable. For example, such vibrations may cause previously-fabricated slices of a partially-built object to move or shift their location in the build bed. This results in a misalignment of adjacent layers, which can cause the parts to have a stair-step surface. In addition, a partially-built object in the build tray can cause perturbations in the degree of levelness of the surface of a powder layer deposited above the object, resulting in undesirable local variations in the thickness of the fabricated layer of the 3D object.

Referring now to the drawings, there is illustrated an example of an additive manufacturing system that provides a layer of build material having a level surface throughout the entire area of the build bed. To facilitate this, a uniform level of the build material is formed in a feeder trough that houses the build material to evenly distribute the build material before the build material is delivered to the build bed. An agitating tray is slidably disposed in the trough, and connected by a drive arm to a linear actuator that is disposed outside the trough and adjacent to an end wall of the trough. The drive arm extends over an end wall of the trough. The linear actuator reciprocates the agitating tray via the drive arm to fluidize the build material in the feeder trough. Once fluidized, gravity can then level, or help level, the build material. The reciprocating motion of the agitating tray may be referred to as vibration or oscillation of the tray. The trough itself is not vibrated

Using the drive arm as the link between the linear actuator and the agitating tray avoids the use of other types of links that pass through one or more holes in a wall of the trough. Because the agitating tray is immersed in the build material during operation, such through-wall links utilize a sealing arrangement around the links to avoid leakage of build material out of the trough and into undesired areas of the additive manufacturing system. These seals, which may be elastomeric, ceramic, or of other compositions, can be a source of high friction. They also wear over time and with use, leading to leakage of build material, failure of seals, seal replacement, and/or system repair. Seals often have lower temperature resistance than other elements of the system. In many cases the build material itself can be abrasive, which can accelerate the wear and bring failure on more quickly. As a result, relative to a subsystem with a thru-wall drive link and seals, the build material preparation subsystems of the present disclosure have improved reliability, lower maintenance, and reduced frictional power losses. The build material preparation subsystems of the present disclosure also can operate at a higher temperature, and provide larger reciprocating stroke distances, than are possible in other subsystems having a thru-wall drive link and seals. As a result, the range of build materials usable with the build material preparation subsystems of the present disclosure can be expanded to include higher temperature materials and/or materials which fluidize better or more rapidly with larger stroke distances.

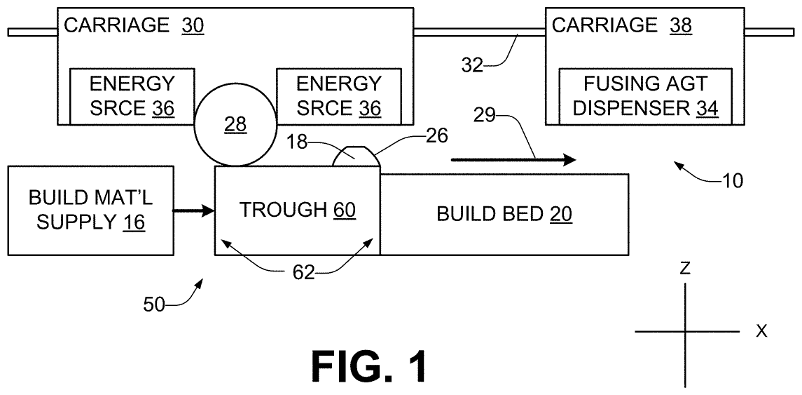

Considering now an example additive manufacturing system, and with reference to FIG. 1, an additive manufacturing system 10 includes a build material preparation subsystem 50 having a trough 60. The system 10 also includes a build material supply reservoir 16 operatively connected to the trough 60, to supply powdered build material from the trough 60 to a build bed (work area) 20. An elongated pile (or “ribbon”) 26 of build material 18 having a substantially uniform cross-sectional area is presented to a spreader roller 28 for layering over the build bed 20 as the roller 28 traverses the build bed 20 in the direction 29. The roller 28 is mounted to a movable carriage 30 that carries the roller 28 back and forth over the build bed 20, for example along a rail 32. The ribbon 26 extends the full width of the build bed 20 in the Y direction (i.e. in and out of the page). The powder reservoir 16 may supply the trough 60 in various ways. In some examples, build material may be pumped or augered through a closed conduit from the supply reservoir 16 to the feeder trough 60. In other examples, build material may be deposited in the feeder trough 60 from a hopper disposed above the trough 60.

The additive manufacturing system 10 also includes a fusing agent dispenser 34 and a source 36 of light, heat, or other fusing energy. In this example, fusing agent dispenser 34 is mounted to a movable carriage 38 that carries the dispenser 34 back and forth over the build bed 20 on the rail 32. In some examples, the energy source 36 is implemented as one or more energy bars 36 (two energy bars 36 in FIG. 1) mounted to roller carriage 30. In operation, a fusing agent is selectively applied to layered build material in a pattern corresponding to an object slice, as the fusing agent dispenser 34 on carriage 38 is moved over the build bed 20. One or more of the energy bars 36 are energized to expose the patterned area to light or other electromagnetic radiation to fuse build material where fusing agent has been applied, as the carriage 30 carrying the energy bars 36 is moved over the build bed 20. The fusing agent absorbs energy to help sinter, melt or otherwise fuse the patterned build material and the material of underlying layers. However, the regions of the powder on which the fusing agent have not been deposited do not absorb sufficient radiated energy to melt the powder. As a result, the portions of the layer on which no fusing agent was deposited remain in unfused powdered form. Fabrication of the 3D object may proceed layer-by-layer and slice-by-slice until the object is complete. A “build bed” as used herein means any suitable structural area to support or contain build material for fusing, including underlying layers of build material and in-process slice and other object structures.

In some examples, the build material may be of a light color, which may be white. In one example, the build material is a light-colored powder. In various examples, the fusing agent is a dark colored liquid such as for example black pigmented ink, an IR or UV absorbent liquid or ink, and/or other liquid(s). In an example, the fusing agent dispenser uses inkjet printing technology.

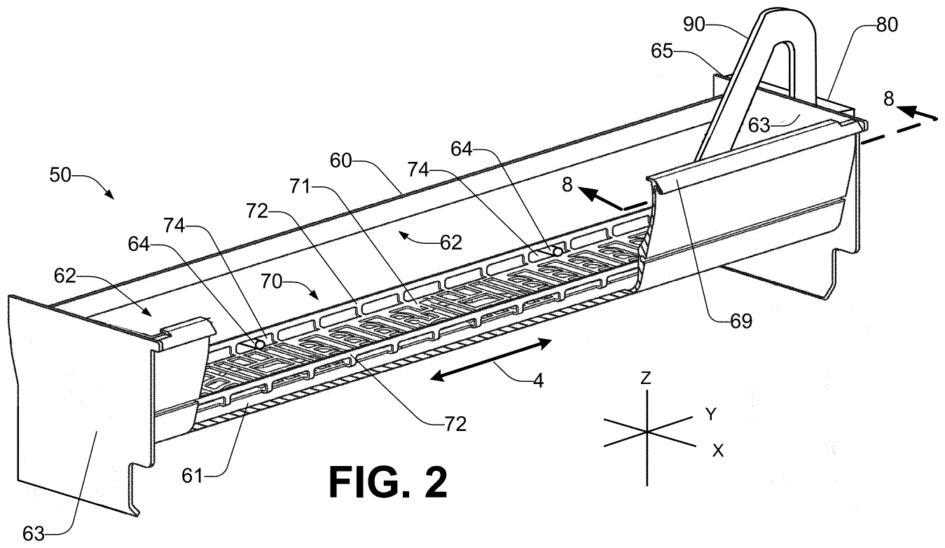

Considering now an example build material preparation subsystem of an additive manufacturing system in greater detail, and with reference to FIG. 2, the build material dispensing subsystem 50 includes the feeder trough 60 to house build material deliverable to a build bed of the AM system. The build material is usable to form a layer of an object fabricated by the AM system. The build bed, although not shown in FIG. 2, may be disposed adjacent an edge 69 of the trough 60 such that a ribbon of the build material may be spread over the build bed as has been explained heretofore with reference to FIG. 1. Part of the trough 60 is cut-away in FIG. 2 to more clearly show other elements.

The feeder trough 60 has a bottom surface 61 and walls generally extending upward from edges of the bottom surface 61. The trough 60 is open at a top surface. The trough 60 may be elongated with two opposing sidewalls 62 and two opposing end walls 63. The trough 60 may be made of any suitable material, and may be shaped to facilitate the delivery of powder from the trough 60 to the build bed, such as for example by curving outward at a top portion. In one example, the trough 60 has a length in the longitudinal direction 4 which is equal to or greater than one dimension of a top surface of its adjacent substantially rectangular build bed. In one example, the trough 60 has outside dimensions in the range of 75 to 150 millimeters in the X direction, 400 to 570 millimeters in the Y direction, and 50 to 120 millimeters in the Z direction.

The trough 60 may be located in a fixed position relative to the build bed, or may be movable relative to the build bed. Where the build bed is removable, the trough 60 and/or build material dispensing subsystem 50 may be removable with the build bed, or may be retained in the AM system when the build bed is removed. Also, the trough 60 and/or the build material dispensing subsystem 50 may be removable and replaceable in the AM system; for example, when changing from one particular type of build material to another.

The dispensing subsystem 50 includes an agitating tray slidably disposed in the trough 60. In some examples, the tray is disposed adjacent the interior bottom surface 61 of the trough 60. The tray has a bottom surface, which in some examples is substantially planar. In some examples, the tray includes at least one sidewall. In some examples, the tray, or a bottom surface of the tray, is mesh-like or screen-like. In some examples, the tray includes features such as, for example, apertures and/or protrusions which may assist with fluidizing, leveling, and/or leveling a surface of the build material in which the tray is immersed during operation. Such features may be formed in the bottom surface and/or at least one sidewall. The tray may also include guiding features which assist with controlled motion of the tray, such as reciprocation, oscillation, and/or vibration.

In one example, a tray 70 has a bottom surface 71 and at least two sidewalls 72. In some examples, two or more pins 64 protrude from each of opposing sidewalls 62 of the trough 60 and engage respective ones of two or more elongated guide slots 74 in each sidewall 72 of the tray 70. The guide slots 74 are elongated in the longitudinal direction 4. In operation, this pin 64 and slot 74 arrangement allows the tray 70 to reciprocate in the longitudinal direction 4, as guided by the slots 74 and pins 64, to agitate the build material sufficiently so as to fluidize it. There is sufficient clearance between the sidewalls 62 and the tray 70 to prevent the tray 70 and the trough 60 from binding during the reciprocation of the tray 70. The slots 74 are sized in the Z direction relative to the diameter of the pins 64 so as to both minimize friction during reciprocation and substantially inhibit movement of the tray 70 in the Z direction. The tray 70 is formed of a material which is moderately rigid to the reciprocating forces so as to avoid wavelike motion of the tray 70 during reciprocation that could push the build material to an end of the trough and thus impair the uniformity of the build material and/or its surface levelness. In one example, the tray 70 is stainless steel between 0.5 millimeters and 1.5 millimeters in thickness. In other examples, the tray may be another metal such as for example aluminum, carbon-filled plastic, or another material(s). In one example, the tray 70 has a bending stiffness in the range from 35-70 N/mm, measured with the tray 70 simply supported at each end with a load applied perpendicularly at the mid-point of the screen and deflection measured at the mid-point.

The dispensing subsystem 50 includes a linear actuator 80 which is disposed outside the trough 60 adjacent one of the end walls 63 of the trough 60. In some examples, the actuator 80 is mounted to the external surface of an end wall 63 below the top of the end wall 63. The dispensing subsystem 50 also includes a drive arm 90 which links the linear actuator 80 to the agitating tray 70. The drive arm 90 extends over the top surface 65 of the end wall 63. The drive arm 90 has a first end portion fixedly coupled to the apertured tray 70 and an opposing second end portion movably engaging the linear actuator 80, as is discussed subsequently in greater detail. The drive arm 90 links the linear actuator 80 to the agitating tray 70 without passing through any wall of the trough 60, and in this way avoids using a trough having at least one hole or orifice in a trough wall to accommodate a through-the-wall drive link. As a result, it also avoids the use of seals or other sealing arrangements for any such holes or orifices in trough walls. Thus the drive arm 90 provides a seal-less connection or link between the tray 70 and the linear actuator 80.

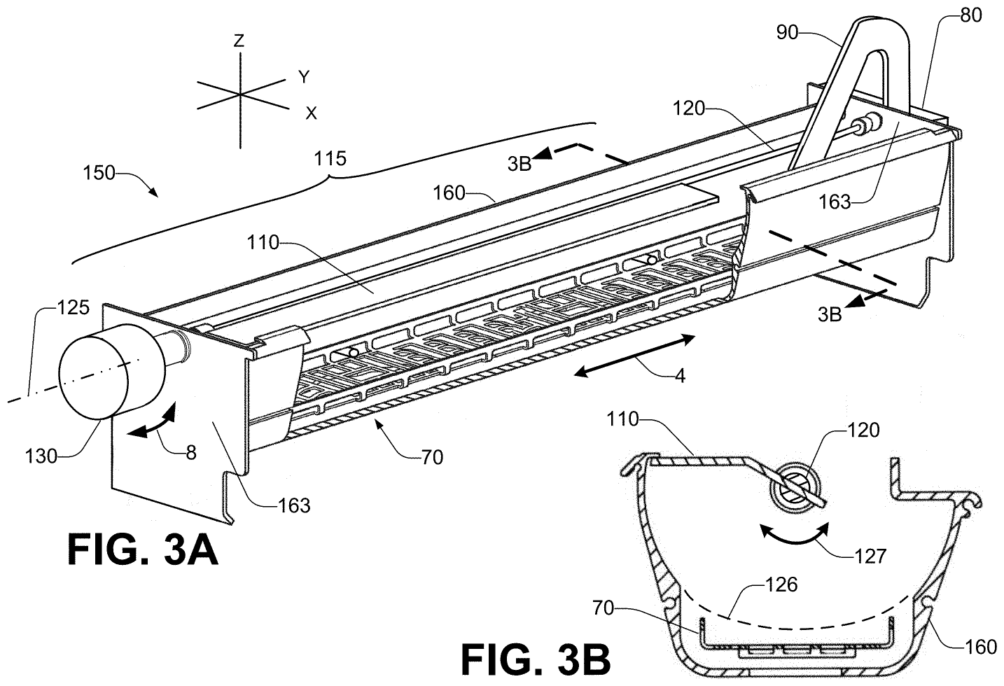

Considering now another example build material preparation subsystem of an additive manufacturing system, and with reference to FIGS. 3A-3B, a build material dispensing subsystem 150 includes a feeder trough 160. FIG. 3B is a section taken along lines 3B-3B of FIG. 3A. The trough 160 is similar to the trough 60 (FIG. 2). The dispensing subsystem 150 also includes an agitating tray 70, a linear actuator 80, and a drive arm 90, as have been described heretofore with reference to FIG. 2.

The build material preparation subsystem 150 also includes an elongated vane (or blade) 110. The vane 110 is disposed above the apertured tray 70. In one example, the vane 110 is fixedly mounted along a rotatable shaft 120 which engages, and it supported by, opposing end walls 163 of the trough 160. In the axial direction of the shaft 120, which is substantially the same as the Y direction 4, the vane 110 is sized to sweep through the build material in the trough 160, as indicated at 126, about an axis 125 which is substantially parallel to the direction 4 of reciprocation of the tray 70 as the shaft 120 rotates on the axis 125. In the Y direction, the vane 110 may extend along a portion of the span of the shaft 120 as in FIG. 3, or alternatively along the entire span of the shaft 120. In some examples, a span 115 of the vane 110 in the Y direction is at least as long as a span of the build bed 20 (FIG. 1) in the Y direction. The vane 110 is substantially rigid, and may be made of aluminum, stainless steel, elastomer, and/or plastic. Elastomer and/or plastic may be used to seal against the side 62 and/or end 63 wall(s) (FIG. 2) The vane 110 may be reciprocated through the build material in an arc in the direction 127 during fluidization. In one example, the arc is about +/−45 degrees from a downward vertical position of the vane 110. To dispense a dose of the build material for deposition on the build bed, the vane 110 may be rotated in a clockwise direction about 180 degrees through the build material to scoop a ribbon of the build material in the trough 160 onto the vane 110 when the vane 110 is positioned as illustrated in FIG. 3B.

The dispensing subsystem 150 also includes a rotary actuator 130 coupled directly or indirectly to the shaft 120, and thus to the vane 110, to rotate the shaft 120 in the direction 8 and sweep the vane 110 through a corresponding arc 127. The rotary actuator 130 may be or include a stepper motor, an air- or electric-driven solenoid, a rack and pinion arrangement, or any suitable rotary actuator and/or gear arrangement.

The linear actuator 80 and the rotary actuator 130 can be considered jointly as a drive arrangement. The actuators 80, 130 can be operated to simultaneously linearly reciprocate the tray 70 and to rotate the vane 110 through an arc, in order to level the build material in the trough 160.

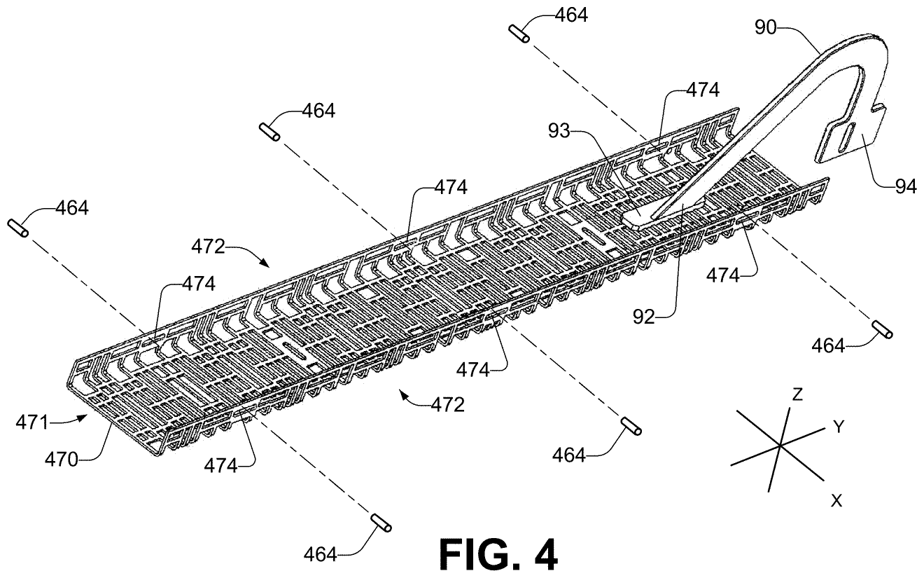

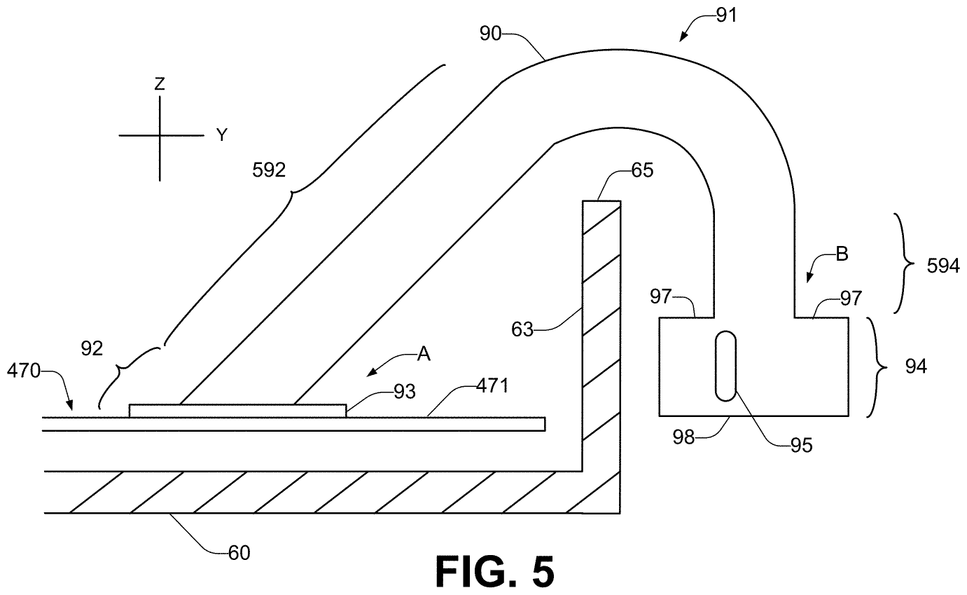

Considering now the drive arm and another example agitating tray usable in a build material preparation subsystem of an additive manufacturing system, and with reference to FIGS. 4-5, an agitating tray 470 is similar to the agitating tray 70 (FIGS. 2-3) but has a different pattern of apertures and/or features. The particular pattern of apertures and/or features used in the agitating tray 470 may be determined at least in part based on the type, grain size, and/or other characteristics of the build material; characteristics of the trough in which the tray is disposed; characteristics of the actuator which reciprocates, oscillates, or vibrates the tray; and/or other factors. The particular pattern of apertures may be chosen to achieve, during operation, an optimal degree of fluidization and/or uniformity of the build material or its surface, or a specified degree of fluidization and/or uniformity of the build material or its surface in the shortest amount of time.

The tray 470 has a generally planar bottom surface or floor 471 and two opposing sidewalls 472 which extend generally upward from opposing edges of the floor 471. Each sidewall 472 has plural guide slots 474. Each guide slot 474 engages a corresponding pin 464 (shown in exploded form) that protrudes substantially in the X direction from a sidewall of a feeder trough (not shown) to slidably engage the tray 470 with the trough. Pins 472 and slots 474 are the same as or similar to pins 72 and guide slots 74 (FIG. 2). In one example, the pins may have a diameter in the range of 2 to 4 millimeters, and the slot may have a length in the Y direction in the range of 12 to 24 millimeters

In one example, the tray 470 has dimensions in the range of 40 to 75 millimeters in the X direction, 375 to 500 millimeters in the Y direction, and 10 to 20 millimeters in the Z direction.

The drive arm 90 has a first end portion 92, and the arm 90 is fixedly connected to the tray 470 at the first end portion 92. The first end portion 92 terminates in a stiffener plate 93 which is fixedly attached to the floor or bottom surface 471 of the tray 470. The stiffener plate 93 provides added rigidity to the tray 470 at the point of attachment, inhibiting or preventing deformation of the tray 470 during reciprocation that could cause undesirable wavelike motion or other perturbations that could delay or prevent the build material from properly fluidizing and leveling.

The drive arm 90 also has a second end portion 94 which is disposed at an opposite end of the arm 90 from the first end portion 92. The second end portion 94 engages a linear actuator 80 (FIG. 1) which is outside the trough, with the drive arm 90 extending over an end wall of the trough.

The drive arm 90 has a upside-down “U” or cup shape, or dome-like shape, when installed in the build material preparation subsystem, with the end portions 92, 94 having a lower position in the Z direction than other portions of the drive arm 90. As a result, the arm 90 includes a bending portion 91. In some examples, the bend 91 is disposed closer to the second end portion 94 than to the first end portion 92. In some examples, the drive arm 90 has a shape like the neck of a goose, and may be referred to as a “gooseneck arm”.

In one example of a gooseneck arm 90, a first, longer elongated linear portion 592 of the arm 90 adjoins the first end portion 92 and forms an angle A of less than 90 degrees with the floor 471 of the agitating tray. A second, shorter elongated linear portion 594 of the arm 90 adjoins the second end portion 94. The second end portion 94 may be, or include, a substantially rectangular drive plate having an elongated slot 95 to receive a drive pin of the linear actuator 80 (FIG. 1). The slot 95 is elongated in substantially the same direction (here, the Z direction) as the second, shorter elongated linear portion 594 which forms an angle B of substantially 90 degrees with the drive plate.

In one example, the drive arm 90 has overall dimensions in the range of 60 to 150 millimeters in the Z direction, 120 to 200 millimeters in the Y direction, and 2 to 10 millimeters in the X direction. In one example, the bending portion 91 has an inner radius in the range of 15 to 50 millimeters, and a thickness in the Y-Z plane in the range of 10 to 20 millimeters from the inner radius to the outer radius. In one example, the stiffener plate 93 is in the range of 12 to 25 millimeters in the X direction, 30 to 50 millimeters in the Y direction, and 0.8 to 1.5 millimeters in the Z direction. In one example, the drive plate of the second end portion 94 is in the range of 1.5 to 4 millimeters in the X direction, 20 to 30 millimeters in the Y direction, and 20 to 50 millimeters in the Z direction. The drive arm 490 is rigid, and may be formed of steel, aluminum, or another suitable material. While a single arm is illustrated in the example of FIG. 4, in other examples dual gooseneck arms 90 may be spaced apart in the X direction and attached to the tray 470.

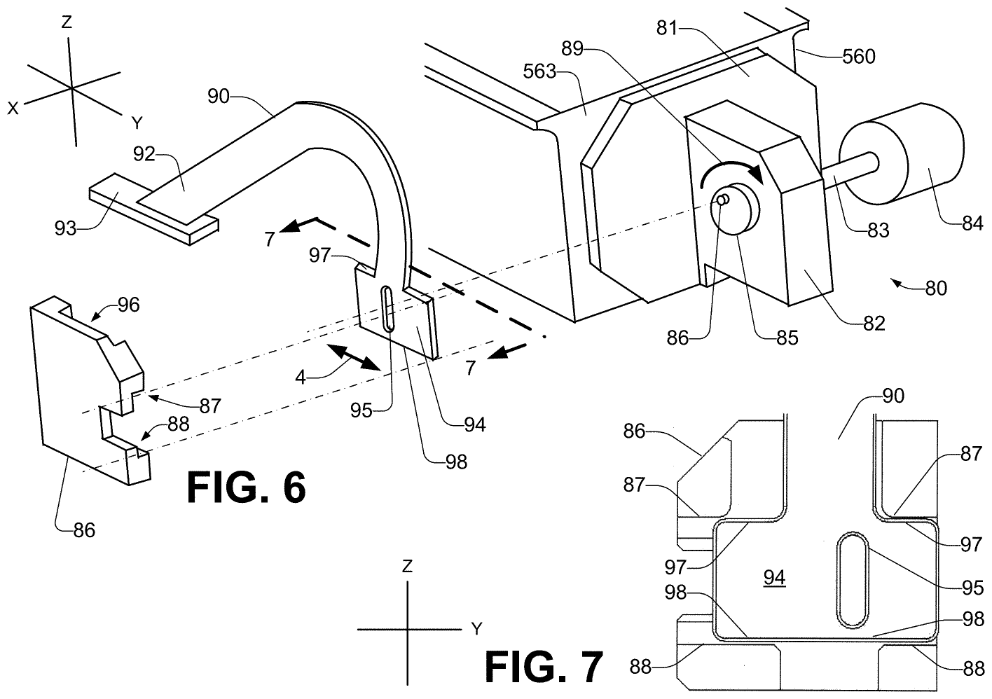

Considering now the reciprocation of the gooseneck arm 90 in greater detail, and with reference to FIGS. 5-7, the linear actuator 80 is illustrated in FIG. 6 in exploded form with some of its support and protective elements omitted for clarity. The linear actuator 80 includes a plate 81 attached to the outside of an end wall 563 of a trough 560 which is similar to the trough 60, 160 (FIGS. 2 and 3A-B). A drive shaft housing 82 is attached to the plate 81 and extends in the Y direction. A drive shaft 83 passes through an orifice (not shown) in the housing 82 and a bearing (not shown) to allow the shaft 83 to freely rotate under control of a motor 84, which in this example is a side-drive motor. The motor 84 may be a stepper motor or another suitable type of motor or actuator, and in some examples may be used with a gearing arrangement. An eccentric 85 having a drive pin 86 is attached to the end of the drive shaft 83. When the linear actuator 80 and the drive arm 90 are assembled, the drive pin 86 engages a drive slot 95 in the second end portion 94 of the drive arm 90. In an example, the drive pin 86 and the drive arm 90, including the drive slot 95, are made of hardened alloy steel in order to minimize wear. In an example, the drive pin 86 may be harder than the drive slot 95.

FIG. 7 is a section taken along the line 7-7 of FIG. 6. With continued reference to FIGS. 6-7, a cover 86 attaches to the drive shaft housing 82 and encloses the second end portion 94 of the drive arm 90. The remainder of the drive arm 90 protrudes through a top slot 96 of the cover 86. The top slot 96 is sized so as to allow the drive arm 90 to reciprocate in the Y direction 4 during operation. The cover 86 mates with the drive shaft housing 82 such that movement of the second end portion 94, and thus the drive arm 90, in the X direction during operation is inhibited. Upper 87 and lower 88 rails of an inner surface of the cover 86 slidably engage top 97 and bottom 98 surfaces of the second end portion 94 of the drive arm 90 when assembled. As the eccentric 85 is rotated with the drive pin 86 engaged with the drive slot 95, the rails 87, 88 inhibit movement of the second end portion 94, and thus the drive arm 90, in the Z direction during operation. As a result, the motion of the drive arm 90 is substantially constrained to the Y direction 4.

In some examples, the cover 86 houses lubricant for the rails 87,88, drive second end portion 94, drive slot 95, and/or eccentric 85. In some examples, the cover 86 is formed of a material which is softer than the agitating tray 70, the drive arm 90, and other elements of the linear actuator 80. In one example, the cover 86 is brass. By making the cover 86 softer, wear that results from operation of the linear actuator 80 will occur at the cover 86, which can be simpler and less expensive to repair or replace than these other components.

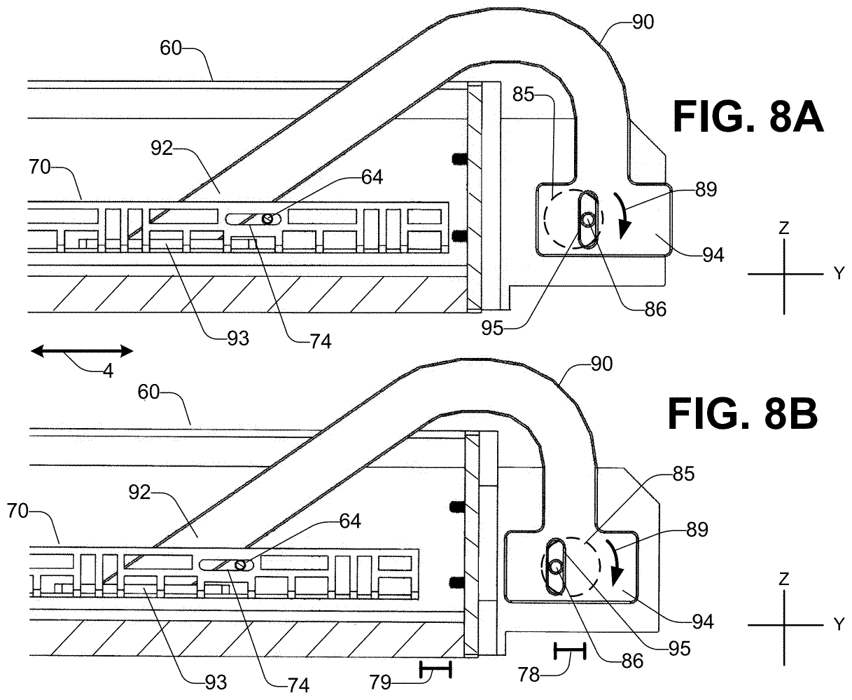

Considering now in greater detail the reciprocation of the tray 70, and with reference to the section view of FIGS. 8A-8B taken along line 8-8 in FIG. 2 and omitting cover 86, the slot 74 which engages the pin 64 is elongated in the Y direction 4 of travel of the tray 70 to allow tray reciprocation. The pin 64 is sized such that the tray can easily move in the Y direction 4, but not in the orthogonal Z direction. As such, tray 70 can reciprocate in the longitudinal direction 4, as guided by the slots 74 and pins 64, to agitate and fluidize build material in the trough 60.

The drive slot 95 of the drive arm 90 is elongated in the Z direction, substantially orthogonal to the direction of travel of the tray 70 during reciprocation. As the eccentric 85 of the linear actuator rotates in the direction 89, the elongation of the drive slot 95 in the Z direction converts the rotational motion of the eccentric 85 into translational motion of the drive arm 90 in the Y direction 4. Any tendency for rotational motion of the drive arm and/or translational motion in the X and/or Z directions is constrained by the cover 86 as discussed heretofore with reference to FIGS. 5-6.

FIG. 8A illustrates a minimum stroke position, while FIG. 8B indicates a maximum stroke position. The distance 78 in the Y direction 4 between the location of the pin 86 at the minimum stroke position and the location of the pin 86 at the maximum stroke position defines the distance 79 over which the tray 70 travels during reciprocation. In one example, the distance 79 is 6 millimeters; in other words, +/−3 millimeters from a central position of the tray 70. In other examples, the distance 79 is another suitable distance. In some examples, the length of the guide slot 74 is longer than the distance 79 in order to avoid interference between the pix 64 and either or both of the ends of the slot 74 during reciprocation.

Forces exerted on the tray 70 in other than the Y direction 4 (i.e. moment arm forces) could cause wear on the tray 70, particularly at the slot 74, and/or on the pin 64. Such forces could also deform or flex the tray, causing wavelike motion or other perturbations that could delay or prevent the build material from properly fluidizing and leveling. In one example, such forces are minimized or eliminated by disposing the guide slot 74 at an elevation in the Z direction that is within a range of elevations in the Z direction occupied by the elongated span of the drive slot 95. In another example, the forces are minimized or eliminated by disposing the guide slot 74 at an elevation in the Z direction that is midway within a range of elevations in the Z direction that is substantially the same as the elevation of the midpoint of elongation of the drive slot 95. In another example, the drive slot 95 is at the same elevation in the Z direction as a center of mass of the tray 70. In a further example, the drive slot 95 is at the same elevation in the Z direction as a center of mass of the combination of the tray 70 and the drive arm 90.

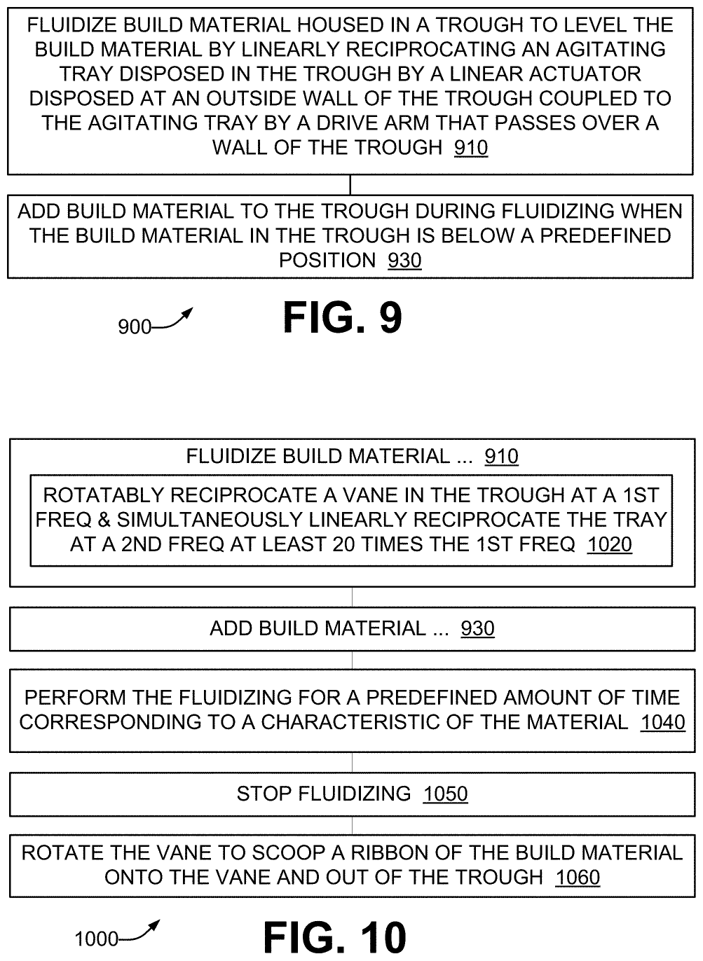

Considering now a method for preparing build material in an additive manufacturing system, and with reference to FIG. 9, the build material to be leveled may be disposed in a trough of a build material preparation subsystem, and the build material in the trough is leveled in preparation for dispensing a ribbon of the build material having a substantially uniform cross-sectional area for spreading across a build bed. A method 900 begins, at 910, by fluidizing non-level build material housed in the trough. The fluidizing is performed by linearly reciprocating an agitating tray disposed in the trough. A linear actuator for controlling the reciprocating is disposed at an outside wall of the trough, and coupled to the agitating tray by a drive arm that passes over a wall of the trough. Using such a drive arm to link the actuator to the tray avoids other types of links which pass through a wall of the trough and thus include seals which can wear and/or allow build material to leak out of the trough.

At 930, build material is added to the trough when the build material in the trough is below a predefined position. In some examples, the build material is added automatically when a top surface of the build material is below the predefined position, in some examples in a region of the build material adjacent a supply source of build material. The build material in the trough may be non-level, such that the build material may be above the predefined position at some places in the trough but below the predefined position at other places in the trough. As the build material is fluidized, the surface of the build material evens out and becomes uniform, and thus build material will be added during the fluidizing if the surface is below the predefined position in the trough. This helps ensure that a sufficient amount (or “dose”) of the build material for the ribbon can be dispensed for delivery to the build bed.

Considering now another method for preparing build material in an additive manufacturing system, and with reference to FIG. 10, a method 1000 includes the build material fluidizing operation 910 and the build material adding operation 930 of FIG. 9.

As part of the fluidizing operation 910, at 1020 a vane disposed in the trough above the tray is rotatably reciprocated in an arc through the build material at a first frequency simultaneously with the linear reciprocation of the agitating tray which occurs at a second frequency. In one example, the second frequency is at least 20 times the first frequency. In one example, the first frequency is in the range of 0.2 to 1 Hertz. In one example, the second frequency is in the range of 5 to 30 Hertz.

At 1040, the fluidizing is performed for a predefined amount of time. In some examples, the predefined amount of times is determined based on at least one characteristic of the build material.

At 1050, fluidizing is stopped. This may include stopping the linear reciprocation of the agitating tray and/or the rotary reciprocation of the vane. At 1060, the vane is rotated through the build material to scoop up a ribbon of the build material onto the vane and raise it out of the trough for delivery to the build bed. The ribbon of build material has a substantially uniform cross-sectional area along the longitudinal span of the vane.

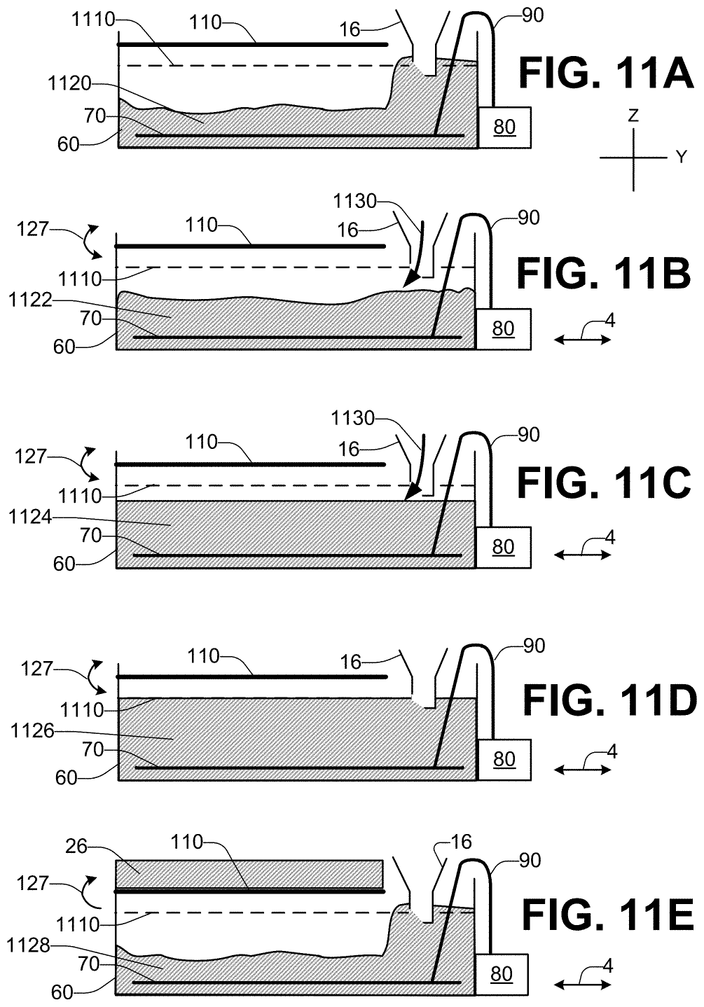

Consider now an example of the operation of a build material preparation subsystem with reference to FIGS. 11A-11E, each of which represents a stage in the preparation of the build material for delivery to the build bed. The subsystem includes a trough 60, an agitating tray 70, a linear actuator 80, a drive arm 90, and a vane 110. The subsystem also includes a build material supply reservoir 16 in the form of a top-down side-feed hopper 16 that supplies build material to the trough 60 at a fixed position via gravity. The hopper 16 is disposed adjacent one end of the trough 60, and thus provides an asymmetric feed of build material to the trough 60. The location in the Z direction of a side-feed nozzle of the hopper 16 defines a desired build material level 1110 to which the trough 60 is to be filled. When the build material reaches the level 1110, the backpressure of the build material at the hopper nozzle stops (self-chokes) the flow of build material from the hopper 16 into the trough 60. In the example system, the vane 110 does not extend across the full width of the trough 60, and does not extend to the location of the hopper 16.

FIG. 11A illustrates a first stage of build material preparation, just after a ribbon of the build material has been delivered to the build bed and the trough is to be refilled with build material at a uniform level. The remaining build material in the trough 60 in FIG. 11A is not at a uniform level in the Y direction. Rather, the build material has a profile 1120, with a low level in the region of the vane 110 where build material has been scooped out to form a cavity in the build material, but a sufficiently high level at the nozzle of the hopper 16 to inhibit feeding of any additional build material into the trough, as the remaining build material has a tendency to remain in place absent the application of external forces to it.

FIG. 11B illustrates a second stage of build material preparation. The linear actuator 80 has been activated, causing linear reciprocation 4 of the tray 70. In some examples, the vane 110 has also been activated to rotatably reciprocate 127 through the trough 60 in an arc (FIG. 3B). Fluidization of the build material causes a change in profile to profile 1122. As the build material fluidizes, gravity begins to level out the build material in the trough 60. The low-level region in FIG. 11A begins to fill in and the high-level region becomes eroded. The level of build material adjacent the side-feed nozzle of the hopper 16 has fallen, eliminating the backpressure at the nozzle and causing a flow 1130 of build material into the trough 60.

FIG. 11C illustrates a third stage of build material preparation. Reciprocation of the tray 70 and vane 110 continues, continuing to fluidize the build material and causing it to self-level to a greater degree in profile 1124. Build material continues to flow 1130 into the trough 60.

FIG. 11D illustrates a fourth stage of build material preparation. Reciprocation of the tray 70 and vane 110 has continued, and sufficient build material has flowed into the trough 60 to reach the desired build material level 1110 and shut off further flow from the hopper 16. Reciprocation of the tray 70 and the vane 110 is stopped at the desired time. The trough 60 contains a desired level of build material of profile 1126, which is uniform and with a generally flat, smooth surface throughout the trough 60. At this point, the build material preparation system is ready to supply another ribbon 26 of build material to the build bed.

FIG. 11E illustrates a fifth stage of build material preparation. The vane 110 has been rotated through the trough to scoop up a ribbon 26 of build material for deposition on the build bed, which is ready to be delivered to the build bed. The removal of the build material from the trough results in profile 1128. After this ribbon 26 has been delivered to the build bed, reciprocation of the tray 70 and vane 110 will begin again, and the process will repeat.

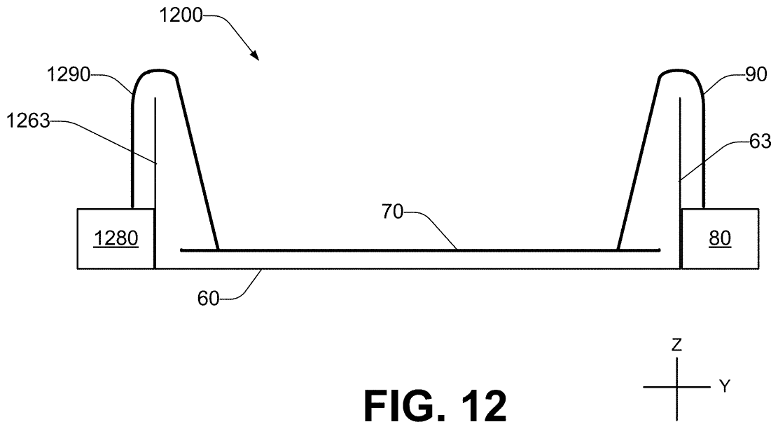

Considering now a build material preparation subsystem having dual drive arms, and with reference to FIG. 12, subsystem 1200 has a trough 60, an agitating tray 70 disposed in the trough 60, a first linear actuator 80 disposed outside the trough 60 adjacent one outside wall 63 of the trough 60, and a first drive arm 90 coupling the linear actuator 80 to the tray 70 by passing over the wall 63.

The subsystem 1200 also has a second linear actuator 1280 and a second drive arm 1290. The second linear actuator 1280 is disposed outside the trough 60 adjacent an opposing outside wall 1263 of the trough 60. The second drive arm 1290 couples the linear actuator 1280 to the tray 70 by passing over the wall 1263. In one example, the second linear actuator 1280 is the same as the first linear actuator 80, and the second drive arm 1290 is the same as the first drive arm 90.

The first and second linear actuators 80, 1280 work in a coordinated manner to reciprocate the tray 70. In one example, the second linear actuator 1280 is 180 degrees out of phase with the first linear actuators 80. In other words, the second linear actuator 1280 is pulling the tray 70 via the second drive arm 1290 when the first linear actuator 80 is pushing the tray 70 via the first drive arm 90, and vice versa. Relative to an asymmetric single drive arm subsystem (such as, for example, subsystem 50 of FIG. 2), a symmetric dual drive arm subsystem 1200 may reduce friction and wear on components of the subsystem 1200, and may improve the effectiveness and/or speed of preparing a uniform layer of build material in the trough 60.

Terms of orientation and relative position (such as “top,” “bottom,” “side,” and the like) are not intended to indicate a particular orientation of any element or assembly, and are used for convenience of illustration and description. The orientation of some of the parts is described with reference to X, Y and Z axes in a three dimensional Cartesian coordinate system in which the X, Y, and Z directions or axes are orthogonal to one another, a plane defined by two axes is orthogonal to a plane formed by any other two axes, and one plane formed by two axes is parallel to any other plane formed by those same two axes.

In some examples, at least one block discussed herein is automated. In other words, apparatus, systems, and methods occur automatically. As defined herein and in the appended claims, the terms “automated” or “automatically” (and like variations thereof) shall be broadly understood to mean controlled operation of an apparatus, system, and/or process using computers and/or mechanical/electrical devices without the necessity of human intervention, observation, effort and/or decision.

From the foregoing it will be appreciated that the subsystems and methods provided by the present disclosure represent a significant advance in the art. Although several specific examples have been described and illustrated, the disclosure is not limited to the specific methods, forms, or arrangements of parts so described and illustrated. This description should be understood to include all combinations of elements described herein, and claims may be presented in this or a later application to any combination of these elements. The foregoing examples are illustrative, and different features or elements may be included in various combinations that may be claimed in this or a later application. Unless otherwise specified, operations of a method claim need not be performed in the order specified. Similarly, blocks in diagrams or numbers (such as (1), (2), etc.) should not be construed as operations that proceed in a particular order. Additional blocks/operations may be added, some blocks/operations removed, or the order of the blocks/operations altered and still be within the scope of the disclosed examples. Further, methods or operations discussed within different figures can be added to or exchanged with methods or operations in other figures. Further yet, specific numerical data values (such as specific quantities, numbers, categories, etc.) or other specific information should be interpreted as illustrative for discussing the examples. Such specific information is not provided to limit examples. The disclosure is not limited to the above-described implementations, but instead is defined by the appended claims in light of their full scope of equivalents. Where the claims recite “a” or “a first” element of the equivalent thereof, such claims should be understood to include incorporation of at least one such element, neither requiring nor excluding two or more such elements. Where the claims recite “having”, the term should be understood to mean “comprising”.

What is claimed is:

1. A build material preparation subsystem for an additive manufacturing system, comprising:
a trough to house build material deliverable to a build bed, the build material usable to form a layer of an object fabricated by the system;
an agitating tray slidably disposed in the trough;
a drive arm having a first end portion coupled to the agitating tray; and
a linear actuator disposed adjacent an outside wall of the trough, the drive arm extending over the wall and having an opposing second end portion engaging the linear actuator to reciprocate the agitating tray to fluidize build material in the trough.

2. The subsystem of claim 1, wherein the drive arm is a first drive arm and the linear actuator is a first linear actuator, comprising:
a second drive arm having a first end portion coupled to the agitating tray adjacent an opposite end of the agitating tray from the first drive arm; and
a second linear actuator disposed adjacent an opposing outside wall of the trough from the first linear actuator, the second drive arm extending over the opposing outside wall and having an opposing second end portion engaging the second linear actuator to reciprocate the agitating tray to fluidize build material in the trough, wherein the first and second linear actuators operate in a coordinated manner.

3. The subsystem of claim 1, comprising:
plural guide slots in each of two opposing sidewalls of the agitating tray, the guide slots elongated in a direction of travel of the tray during reciprocation of the tray; and
plural pins extending from each of two opposing inner walls of the trough, each pin slidably engaging a different one of the slots.

4. The subsystem of claim 1, wherein the second end of the drive arm includes:
a drive slot elongated in a direction substantially orthogonal to a direction of travel of the tray during reciprocation of the tray, and
parallel top and bottom surfaces extending substantially in the direction of travel.

5. The subsystem of claim 4, wherein the linear actuator includes:
a cover having fixed guide rails engaging the top and bottom surfaces of the second end portion of the drive arm respectively;
an eccentric having a pin engaging the drive slot; and
a motor to turn the eccentric to reciprocate the drive arm in the direction of travel of the tray.

6. The subsystem of claim 5, wherein the guide slot is disposed at an elevation that is within a range of elevations occupied by the elongated span of the drive slot.

7. The subsystem of claim 1, comprising:
a vane rotatable about an axis substantially parallel to the direction of reciprocation of the tray and above the agitating tray, the vane sized to sweep through the build material in the trough as the vane rotates.

8. A build material preparation subsystem for an additive manufacturing system, comprising:
a trough to house build material deliverable to a build bed, the build material usable to form a layer of an object fabricated by the system;
an agitating tray slidably disposed adjacent a bottom surface of the trough;
a linear actuator disposed outside the trough and adjacent a wall of the trough; and
a drive arm having a first end portion fixedly coupled to the agitating tray and a second end portion coupled to the linear actuator, the drive arm passing over a wall of the trough.

9. The subsystem of claim 8, wherein the drive arm is a rigid structure and has a gooseneck shape with a bend disposed closer to the second end portion than the first end portion.

10. The subsystem of claim 8, wherein the agitating tray has a floor, and wherein an elongated linear portion of the drive arm adjacent the first end portion forms an angle less than 90 degrees with the floor.

11. The subsystem of claim 8, wherein the first end portion terminates in a stiffener plate attached to a floor of the tray.

12. The subsystem of claim 8, wherein:
the second end portion includes a substantially rectangular drive plate;
an elongated linear portion of the drive arm adjacent the second end portion forms an angle of substantially 90 degrees with the drive plate; and
the drive plate includes an elongated slot to receive a drive pin, the slot elongated in substantially the same direction as the elongated linear portion.

13. A method for leveling build material in an additive manufacturing system, comprising:
fluidizing non-level build material housed in a trough to level the build material by linearly reciprocating an agitating tray disposed in the trough by a linear actuator disposed at an outside wall of the trough, the linear actuator coupled to the agitating tray by a drive arm that passes over a wall of the trough; and
automatically adding build material to the trough during the fluidizing when the build material in the trough is below a predefined position.

14. The method of claim 13, wherein the fluidizing further comprises:
rotatably reciprocating a vane disposed in the trough above the tray at a first frequency simultaneously with linearly reciprocating the agitating tray at a second frequency, the second frequency at least 20 times the first frequency.

15. The method of claim 13, comprising, after the fluidizing:
stopping reciprocation of the tray; and
rotating the vane to scoop a ribbon of the build material onto the vane and out of the trough, the ribbon having a substantially uniform cross-sectional area along a longitudinal span of the vane.
